(19) United States
(12) Patent Application Publication
(10) Pub. No.: US 2007/0018426 A1
(43) Pub. Date: Jan. 25, 2007

(54) Mobile transport chair assembly

(76) Inventor: Phillip Minyard Willis, Duluth, GA (US)

Correspondence Address: MALLOY & MALLOY, P.A., Historic Coral Way, 2800 S.W. Third Avenue, Miami, FL, 33129, US

(21) Appl. No.: 11/129,568

(22) Filed: May 13, 2005

(51) Int. Cl. A61G 5/10

(52) U.S. Cl. 280/304.1; 280/650

(57) ABSTRACT

A chair assembly structured to transport a user while in a seated position comprising a collapsible frame selectively disposed between an operative orientation and collapsed orientation. The frame includes two side portions movably connected to one another, wherein a handle assembly and a foot support assembly are movably connected to the side portions. The side portions, handle assembly and foot support assembly are cooperatively structured along with other structural components of said chair assembly to assume a compact configuration of sufficiently reduced transverse and longitudinal dimensions to facilitate reduced volume storage of said frame when in said collapsed orientation.

### BACKGROUND OF THE INVENTION

1. Field of the Invention

This invention is directed to a mobile chair assembly having a frame selectively positionable between an operative orientation and a collapsed orientation. Two side portions of the frame are movably connected to one another and interconnected to other operative and structural components of the chair assembly such that the frame can assume a compact configuration of sufficiently reduced transverse and longitudinal dimensions to facilitate a reduced volume storage and/or transport thereof, when the frame is in the collapsed orientation.

2. Description of the Related Art

Numerous individuals suffer from a lack of mobility because of age, medical conditions or the like. As a result, such individuals frequently require some type of mechanical aid or device in order to facilitate their ability to move from one location to the next. Known devices which are readily available on the commercial market include “walker” assemblies which typically allow an individual to support oneself in an upright, substantially stable orientation while standing or walking. For the less infirmed, know walker assemblies allow the individual to safely traverse over both interior and exterior support surfaces such as floors, sidewalks, streets, etc. Also, conventionally structured walkers may or may not include supporting wheel assemblies. When present, such wheel assemblies may increase the mobility of a user, but can somewhat lessen the stability thereof, especially when all four legs of the walker frame have a wheel, roller or like structure attached to the lower end thereof.

The advantage of known walker assemblies, over other mobility aiding devices, includes a smaller frame of generally lightweight construction which may be more easily stored and or transported than other devices, when not in use. In order to further facilitate the storage and or transport thereof some known or conventional walkers are foldable, allowing them to be easily disposed within the trunk or other convenient or appropriate area of a vehicle. However, the collapsibility of known walkers, as well as other mobility aiding devices may be limited in that the walker still must offer sufficient structural integrity as well as provide adequate stability and support to an individual when in use.

Other mobility aids commonly used comprise walking canes. While it is acknowledges that such walking canes or “walking sticks” may be used primarily for decorative purposes and/or as a fashion accessory, other cane structures are specifically designed to be used by less mobile individuals as in auxiliary means of support and stability when walking, standing, etc. Walking canes falling in this latter category should include sufficient structural integrity to allow an individual, having physical limitations to safely move over a variety of different surfaces.

Yet another category of devices used to facilitate the mobility of individuals having more significant physical limitations include mobile chair structures or “wheelchairs”. An increased use of the wheelchair has occurred in recent years, due, at least in part, to an increasingly aging population. As such, the development of the wheelchair, in various forms, has progressed from the smaller, less bulky wheelchair structures of somewhat lightweight construction to the heavier, larger chair assemblies. In addition, more sophisticated wheelchair designs are motorized and while such mobility aids are expensive, they are still relatively common. Clearly, the larger, more complex and/or motorized wheelchair assemblies have distinct advantages in terms of facilitating mobility without requiring significant manual exertion by the user. In addition, control assemblies associated with the steering and operation of the more sophisticated motorized wheelchair structures are capable of allowing the substantially independent use thereof by individuals which are significantly disabled and/or almost totally paralyzed.

Despite the advantages of the type set forth above, the larger more sophisticated wheelchair structures do have certain disadvantages relating to the storage and transport thereof when not in use. In order to overcome such disadvantages, collapsable wheelchairs have been developed which are easier to handle, transport and store, when not in use. However, many collapsible wheelchair structures still assume a bulky configuration, even when in a folded orientation, thereby requiring a significant amount of space when stored or loaded into the trunk or other appropriate location of a vehicle. Moreover, even when intentionally disposed in a collapsed or folded orientation, one or more dimensions of the wheelchair, such as the longitudinal and/or transverse dimension, is often times not sufficiently reduced to significantly facilitate the storage or transport thereof.

Therefore, despite the developments and advancements in mobility aiding devices of the type set forth above, there is still a need for an improved mobility aid which provides significant and appropriate support and stability to an individual while being capable of being easily and quickly configured into a collapsed or stored orientation. Further, such a stored orientation should preferably comprise a compact configuration having sufficiently reduced transverse and longitudinal dimensions to significantly enhance the ability to store and/or transport such devices. More specifically, there is a significant and long felt need for an improved transport chair assembly which is capable of being selectively disposed between an operative orientation for use and a collapsed orientation for storage and transport. If developed, such a preferred transport chair assembly should comprise a frame as well as other operative components which are cooperatively structured to greatly enhance the mobility of an individual regardless of the degree of disability, when in an operative position.

### SUMMARY OF THE INVENTION

The present invention is directed to a mobile chair assembly used to transport disabled individuals while in a seated position. The chair assembly comprises frame selectively disposable between an operative orientation when in use and a collapsed orientation which facilitates storage and or transport thereof, when not in use. The frame includes two side portions which are movably interconnected to one another in a manner which provides stability to a supported user and facilitates the selective positioning of the frame between the operative and collapsed orientations. Supported by and interconnected between the two side portions is a seat structure and a backrest each formed of a flexible and/or foldable material which further facilitates the operative or collapsed positioning of the frame.

In addition, a preferred embodiment of the chair assembly of the present invention comprises a handle assembly which is disposable between an extended position and a retracted position. The handle assembly is connected to the two side portions and movable with and relative to the side portions, depending on the frame being operatively oriented or collapsed. Structural features associated with the handle assembly which facilitate both the steering of the chair assembly, when in use, as well as collapsed orientation of the frame when not in use include two hand grip members each secured to an outer end or portion of a different one of the two handle members. As such, each hand grip includes an inwardly flared flange or hand rest. Moreover, the hand rest flange is cooperatively disposed and configured, along with an at least minimal angular orientation of the handle members, to allow the exterior, lateral positioning of the handle members immediately adjacent to corresponding side portions thereof, when the frame is collapsed.

Additional structural features include the provision of a foot support assembly including two foot support members each having a foot pad attached to the outer most in thereof. Again, the collapsed orientation of the frame is further and at least partially defined by the structuring of the foot members to be movable relative to the corresponding portion to which it is attached and or be removable there from. Yet additional structural features of the chair assembly which further facilitate its storage and/or transport when not in use is the ability to remove the wheels or like structures, when in the aforementioned collapsed orientation. The overall size, configuration, etc of the chair assembly is thereby proportionately reduced.

Therefore, the overall structural and operative features of the preferred embodiment of the chair assembly, allow the various structural components associated therewith to be selectively fixed and movable relative to one another. As such, the frame of the chair assembly is capable of assuming a compact configuration. The compact configuration is more specifically defined by a significantly and sufficiently reduced transverse dimension and longitudinal dimension, when the frame is in the collapsed orientation, to greatly enhance the ability to store and transport the chair assembly. Accordingly, the chair assembly of the present invention provides a safe, reliable and effective means of enhancement of an individual's mobility, while overcoming many of the problems and disadvantages associated with wheelchairs or like mobility aiding vehicles commonly known and utilized.

Moreover, when in the collapsed orientation, the frame and the various components associated therewith assume a compact configuration of sufficiently reduced size to facilitate the chair assembly being easily and quickly placed within a pouch, bag or like container during the storage and or transporting thereof.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a perspective side view of a preferred embodiment of the chair assembly of the present invention.

FIG. 2 is a perspective front view in partial cutaway of the embodiment of FIG. 1.

FIG. 3 is a rear perspective view of the embodiment of FIGS. 1 and 2.

FIG. 4 is a perspective side view in partial cutaway of structural details of the handle assembly associated with the embodiment of FIGS. 1 thru 3.

FIG. 5 is a perspective side view in partial cutaway of the chair assembly in a collapsed orientation.

FIG. 6 is a perspective side view in partial cutaway of the wheel assembly associated with the frame of the chair assembly of the present invention when in an operative orientation.

Like reference numerals refer to like parts throughout the several views of the drawings.

### DETAILED DESCRIPTION OF THE PREFERRED EMBODIMENT

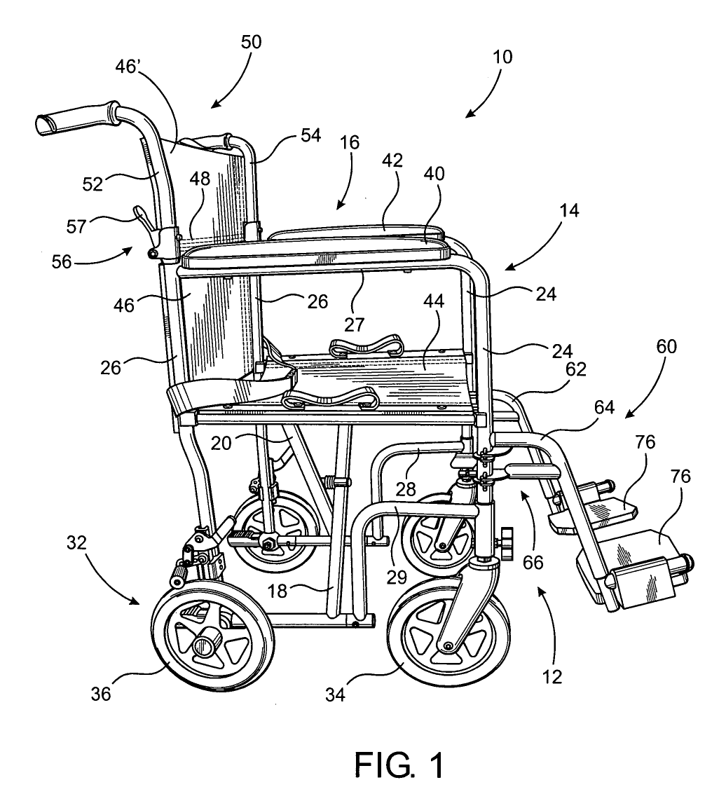

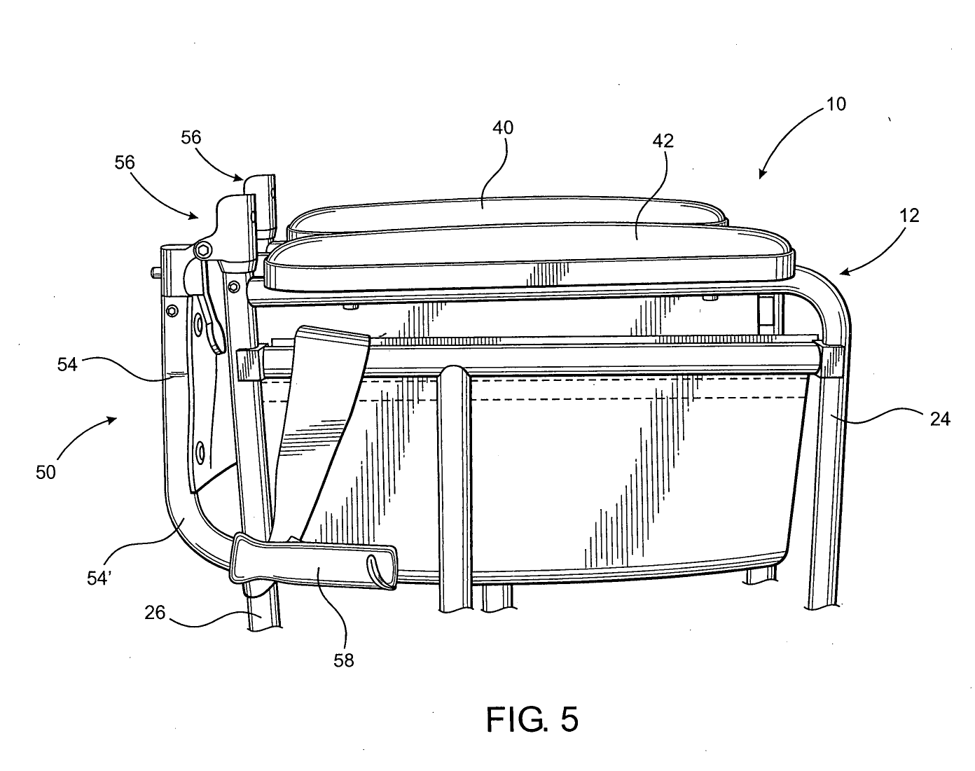

As shown in the accompanying drawings, the present invention is directed to a chair assembly generally indicated as 10 which is structured to be mobile and as such serves to transport an individual over any of a variety of different support surfaces. Moreover, the chair assembly 10 includes a frame generally indicated as 12 which is selectively positionable between an operative orientation when intended to be used, as demonstrated in FIGS. 1 thru 3 and a collapsed orientation as represented in FIG. 5. As should be apparent, the collapsed orientation of the chair assembly 10 is assumed when the chair assembly 10 is not intended for immediate use. As will be described in greater detail hereinafter, when in the collapsed orientation of FIG. 5 the chair assembly 10 assumes a compact configuration which greatly facilitates its storage and or transport due to the significally smaller volume in which the collapsed chair assembly 10 may be stored.

Specific structural details of the frame comprise two side portions 14 and 16 which are pivotally interconnected by brace members 18 and 20 movably attached by a bolt or like connecting structure 22. By virtue of the connection 22, as well as other structural and operative features of the frame 12, it is easily disposable between the aforementioned operative orientation of FIGS. 1 thru 3 and the collapsed orientation, as at least partially represented in FIG. 5. While the individual side portions 14 and 16 may assume a variety of different structural configurations, a most preferred embodiment of the frame 12 includes the two side portions 14 and 16 being substantially equivalently structured and including front and rear leg members 24 and 26 as well as spaced apart cross braces 27, 28 and 29. The cross braces 27 and 28 preferably have a substantially linear configuration and the lower most cross brace 29 is specifically configured to accommodate movement and positioning of the front and rear wheel assemblies, generally indicated as 30 and 32.

As such, the front and rear wheel assemblies 30 and 32 each include a pair of wheel structures respectively comprising front wheel structures 34 and rear wheel structures 36. As represented, the front wheel structures 34 of the front wheel assembly 30 are defined by castors or like wheel structures capable of rotating 360° about the axis of the front leg members 24, thereby providing greater maneuverability of the chair assembly 10 when in use. In order to further reduce the overall size and configuration of the chair assembly 10, when in a collapsed orientation, at least the front wheel structures 34 may be removed, such as by manually loosening the corresponding threaded lock knobs 34′ or otherwise manipulating connecting structure associated with the front wheel structures 34.

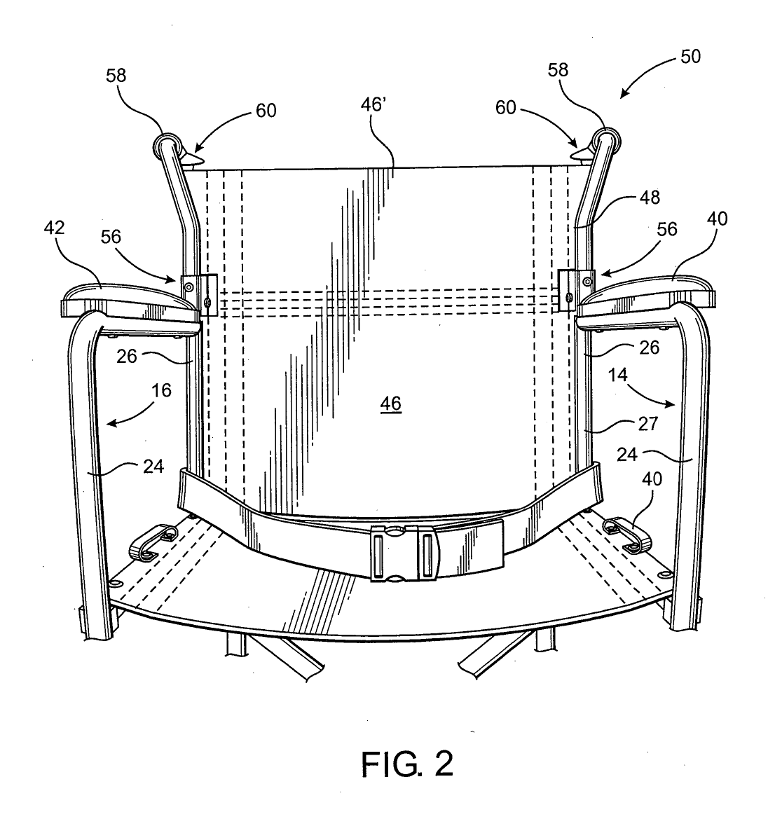

Other structural features include two armrests 40 and 42 connected to and supported by a length of the uppermost cross brace 27. The arm rest 40 and 42 may be at least partially cushioned to add to the comfort of the user of the chair assembly 10. In addition, the frame 12 includes a seat 44, which is disposed in a transversely expanded position as demonstrated in FIGS. 1 and 2, when the frame 12 is in the operative orientation as represented. In order to further provide adequate support to a user, when in a seated position, the frame 12 also includes a backrest 46 extending between the two rear leg members 26, wherein the backrest 46 also expands transversely between the two side portions 14 and 16 when the frame 12 is in its operative orientation. As a further note, the backrest 46 also includes an additional upper segment as at 46′ which is connected to the main backrest portion 46 along a fold line or seam 48.

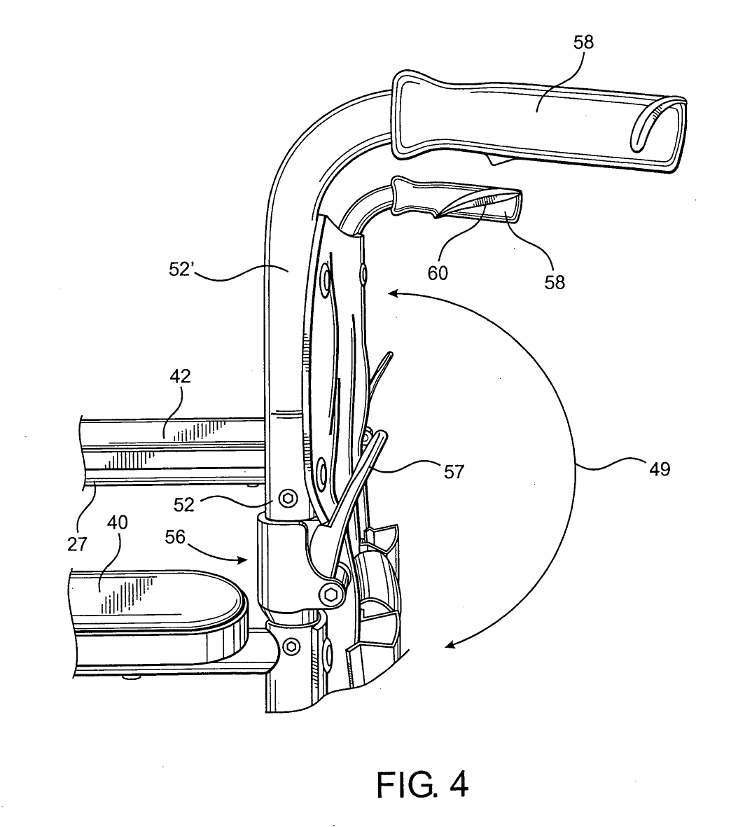

In order to facilitate disposition of the two side portions 14 and 16 in the adjacent, side-by-side relation to one another when the frame 12 is in the collapsed orientation, the seat structure 44 and the backrest 46, 46′ is formed at least in part from a flexible and or foldable material. As such, both the seat and the main portion 46 of the backrest is folded or otherwise disposed between correspondingly disposed portions of the two side portions 14 and 16 when the frame 12 is in the collapsed orientation at least partially represented in FIG. 5. Further structural features of the backrest 46, 46′ include its ability to be folded rearwardly, as at least partially and schematically indicated by directional arrow 49 of FIG. 4, about the seam or junction 48 by virtue of selectively positioning the handle assembly general indicated as 50 between the extended position demonstrated in FIGS. 1 thru 3 and the retracted position as demonstrate in FIG. 5.

As represented, the handle assembly 50 includes two handle members 52 and 54 having their lower or inner most end portion pivotally connected to corresponding side portion 14 and 16. More specifically each of the handle members 52 and 54 are pivotally interconnected to the rear leg portions 26 by a locking hinge type connecter generally indicated as 56. As currently represented in FIGS. 1 thru 3 and 5, the locking hinge structure 56 is capable of removably locking the respective handle members 52 and 54 in the outwardly extended position as shown in FIGS. 1 thru 3. However, upon manual manipulation of a release tab 57 associated with each of the locking hinge structures 56, each of the hinge structures 56 are structured to release the corresponding handle members 52 and 54 allowing them to fold or be pivotally disposed rearwardly (see directional arrow 49 of FIG. 4) of the frame 12, into the retracted position of FIG. 5.

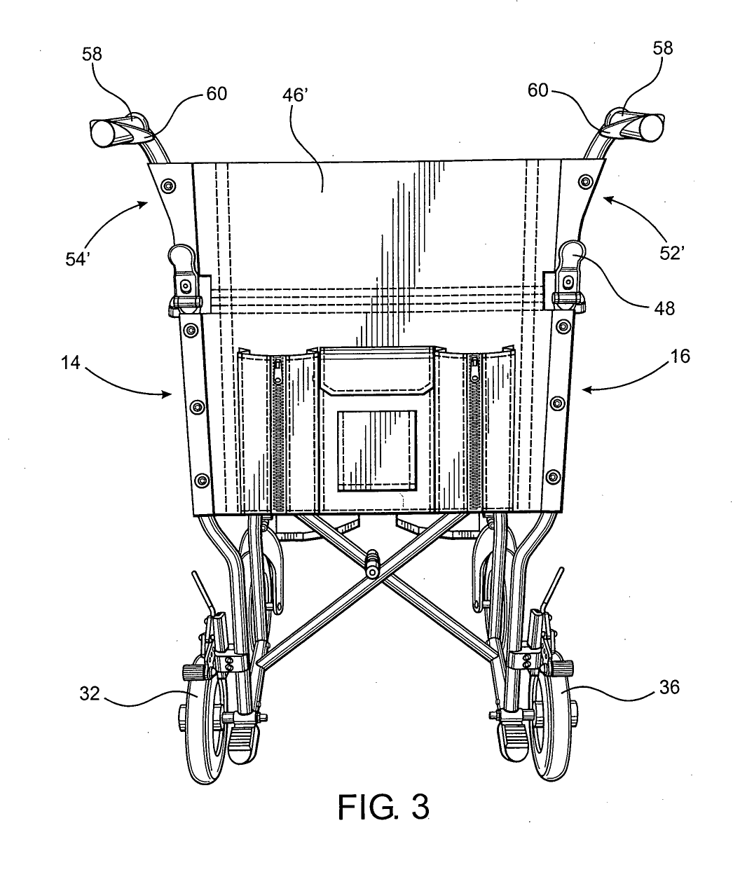

With further reference to FIG. 5, the retracted position of the handle members 52 and 54 is also defined by at least a portion of handle member 52 and 54 disposed in laterally adjacent relation to corresponding ones of the rear leg members 26. As represented in FIGS. 2 and 3, each of the handle members 52 and 54, when pivotally disposed back into the extended position as also indicated by directional arrow 49, are at least partially aligned with the length or longitudinal access of the corresponding rear leg members 26. However, a significant portion of the length of each of the handle members 52 and 54 are angled outwardly as at 52′ and 54′. This outwardly angled orientation facilitates the intended positioning of the handle members 52 and 54 into the aforementioned retracted position. Therefore, the retracted position is defined by a laterally adjacent orientation of at least a portion the length of each of the handle members 52 and 54, while the corresponding outwardly angled, upper portions 52′ and 54′, are located laterally outward or exteriorly of the corresponding rear leg members 26.

An additional structural and operative feature of the handle assembly 50 comprises two hand grip members each represented as 58. Each hand grip member 58 includes an inwardly directed flared hand rest portion 60. The hand grip 58 in cooperation with the inwardly flared hand rest portion 60 facilitates steering and maneuvering of the chair assembly 10 when in its operative orientation. In addition, when the handle assembly 50 is disposed in the retracted position of FIG. 5, the inwardly flared hand rest portion 60 are disposed in interruptive engagement with the upper portions of the rear leg members 26 so as to removably but firmly retain the handle members 52 and 54 in the retracted position.

Accordingly, one structural and operative feature of the chair assembly 10 of the present invention is the positioning of the frame 12 into the collapsed orientation at least partially demonstrated in FIG. 5. Further, when in the collapsed orientation, storage and or transport of the frame, as well as the various components cooperatively associated therewith, is greatly facilitated by virtue of the fact that the frame is disposed in a compact configuration characterized by and comprising a significantly reduced transverse dimension and longitudinal dimension, from that assumed by the frame 12 when in the operative orientation of FIGS. 1 thru 3.

More specifically, the reduced transverse configuration of the frame 12, when in the collapsed orientation, is at least partially defined by the two side portions 14 and 16 disposed in side-by-side adjacent relation to one another. As such, the seat structure 44 and the backrest assembly 46, 46′ are foldable or otherwise disposed between the side portion 14 and 16. In a complimentary fashion, the reduced longitudinal dimension of the frame 12 comprises and/or is at least partially defined by the handle assembly 50 being pivoted or otherwise disposed along a path at least partially defined by the directional 49, into the retracted position of FIG. 5. When so disposed the longitudinal dimension of the overall frame assembly 12 is significantly reduced by virtue of the handle members 52 and 54 being disposed exteriorly of and laterally adjacent to the rear leg members 26, as discussed in detail above.

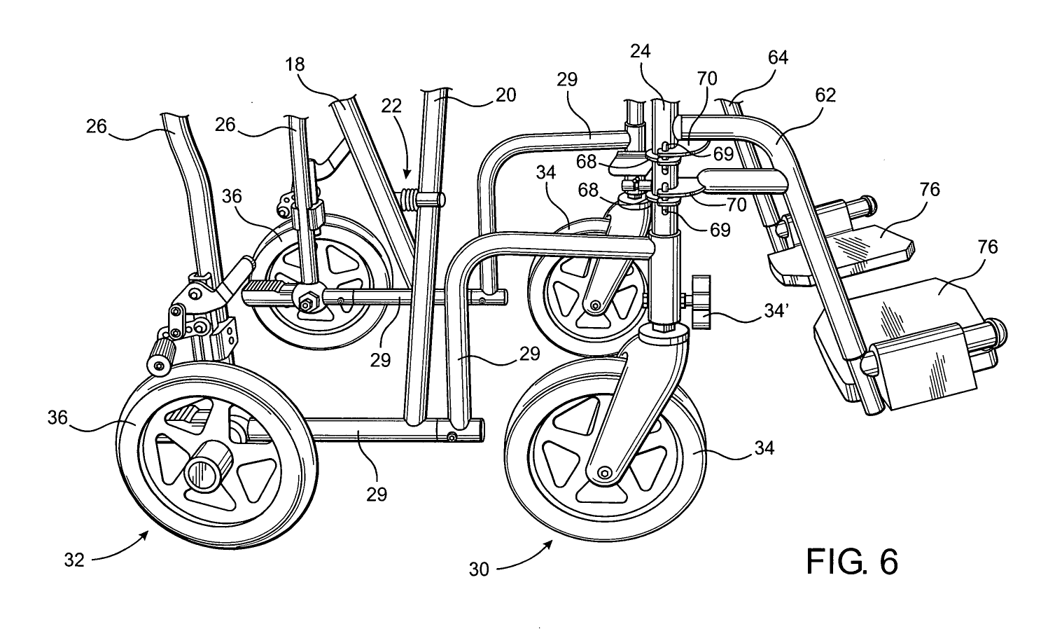

The preferred compact configuration of reduced longitudinal and transverse dimensions of the frame 12 is further facilitated by the movable and/or removable connection of the leg support assembly generally indicated as 60. The leg support assembly 60 includes two leg support members 62 and 64 having substantially elongated configurations and further including foot support pads 66 connected to the lower or distal end of each of the leg support members 62 and 64. As perhaps best shown in FIGS. 1 and 6, each of the leg support members 62 and 64 are both movably and removably interconnected to correspondingly positioned ones of the front leg members 24 by a locking hinge-like connector generally indicated as 66.

Each connector 66 includes at least a portion thereof fixedly secured to each of the front leg members 24 and at least partially defined by spaced apart pivot plates 68. Hinge pins 69 are secured to each of the plates 68 and are disposed and structured to pass through receiving apertures formed in corresponding plates 70 formed on a portion of the hinge-like connector 66 which is secured to the inner or upper most end of each of the leg support members 62 and 64. A lever 72 associated with each of the connectors 66 serves to release hinge plates 70 from the hinge plates 68 thereby facilitating rotation of each of the leg support members 62 and 64 from the outwardly extending orientation demonstrated in FIG. 1 to exterior, laterally adjacent side orientation adjacent to the lower cross brace members 29.

In addition, the hinge plates 70 associated with each of the foot support members 62 and 64 may be detached from the corresponding hinge plates 68 of the connector 66 by lifting the plate 70 off of the hinge pins 69. Accordingly, a further reduction in the overall dimension of the frame 12 and the chair assembly 10 when in the collapsed orientation is demonstrated by the removal of the foot support members 62 and 64 or by their laterally adjacent side-by-side positioning relative to corresponding side portions 14 and 16 and more specifically the lower most cross brace 29 associated therewith.

Based on the above, the transport chair assembly 10 facilitates comfortable, stable and efficient transport of an individual while in a seated position over a variety of different surfaces, while the frame 12 is in the aforementioned operative orientation as demonstrated in FIGS. 1 thru 3. However, when it is desired to store or otherwise transport the chair assembly 10, when not in use, the frame 12 maybe selectively disposed into the collapsed orientation generally defined by a compact configuration thereof which is further characterized by the frame having a significantly and sufficiently reduced transverse and longitudinal dimension due in least a part to a side-by-side positioning of the side portions 14 and 16 and the further positioning of the handle assembly 50 in the retracted position, all of which are described in detail above. A further reduction in the overall configuration and dimension of the frame 12 is also characterized by a removal of the foot support assembly or the positioning thereof laterally adjacent to the corresponding side portions 14 and 16. Also, the overall dimensions of the frame 12 are sufficiently reduced to allow it to be easily placed within a carrying bag, pouch or like container to further facilitate its storage and/or transport in a efficient manner.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A chair assembly structured to transport a user while in a seated position, said chair assembly comprises;
a mobile frame selectively disposable between an operative orientation and a collapsed orientation,
said frame comprising two side portions movably interconnected to one another and disposed in supporting relation to a seat structure,
said frame further comprising a handle assembly moveably connected to said side portions and disposable between an extended position and a retracted position, and
said side portion and said handle assembly cooperatively structured to assume a compact configuration of sufficiently reduced transverse and longitudinal dimensions of said frame to facilitate storage thereof when in said collapsed orientation.

2. A chair assembly as reciting claim 1 wherein said collapsed orientation comprises said side portions disposed in substantially adjacent, side-by-side relation to one another thereby at least partially defining said reduced transverse dimension of said frame.

3. A chair assembly as reciting claim 2 wherein said seat structure is folded between said side portions when said side portions are in said substantially adjacent relation to one another.

4. A chair assembly as recited in claim 3 wherein said seat structure is formed of a substantially flexible material.

5. A chair assembly as recited in claim 2 wherein said reduced longitudinal dimension is at least partially defined by said handle assembly pivotally disposed out of said extended position and into said retracted position.

6. A chair assembly as recited in claim 5 wherein said collapsed orientation is at least partially defined by said side portions disposed in said substantially adjacent, side-by-side relation to one another and said handle assembly pivotally connected to said side portions and movable rearward of said frame into said retracted position.

7. A chair assembly as recited in claim 1 wherein said collapsed orientation further comprises said handle assembly pivotal relative to said side portions into said retracted position.

8. A chair assembly as recited in claim 7 wherein said retracted position comprises said handle assembly disposed in laterally adjacent relation to said side portions thereby at least partially defining said reduced longitudinal dimension.

9. A chair assembly as recited in claim 8 wherein said extended position comprises said handle position removably locked to and extending outward from said side portions and in at least partial linear alignment therewith.

10. A chair assembly as recite din claim 1 further comprising a backrest connected to said handle assembly and at least partially moveable therewith between said extended and retracted positions.

11. A chair assembly as recited in claim 10 wherein said backrest is further connected to said side portion and is disposable into and out of expanded orientation dependent of said frame being disposed in said operative or collapsed orientation.

12. A chair assembly as recited in claim 10 wherein said backrest is concurrently pivotal with said handle assembly into said retracted position and with said side portions into said substantially adjacent relation to one another, thereby at least partially defining said reduced transverse and longitudinal dimensions.

13. A chair assembly as recited in claim 1 wherein said handle assembly comprises two handle members each pivotally connected to a different one of said side portions.

14. A chair assembly as recited in claim 13 wherein each of said handle members is movable with and relative to a corresponding one of said side portions when said frame is disposed between said operative and collapsed orientations.

15. A chair assembly as recited in claim 13 wherein each of said handle members comprises a hand grip secured thereto, each of said hand grips and at least a portion of each of said handle members disposed laterally outward from a corresponding one of said side portions to facilitate disposition of said handle assembly in said retracted position.

16. A chair assembly as recited in claim 15 wherein said retracted position comprises said handle members disposed in outward, laterally adjacent relation to corresponding ones of said side portions.

17. A chair assembly as recited in claim 16 wherein said retracted position comprises said hand grips disposed laterally adjacent to and outwardly from corresponding ones of said side portions.

18. A chair assembly as recited in claim 1 further comprising a foot support assembly movably connected to said to side portions and selectively disposable between a supporting orientation and a stored orientation.

19. A chair assembly as recited in claim 18 wherein said stored orientation comprises said foot support assembly disposed in outward, laterally adjacent relation to said side portions.

20. A chair assembly as recited in claim 18 wherein said foot support assembly is removable from and movable relative to said to side portions, said stored position comprising said foot support assembly detached from said to side portions.

21. A chair assembly as recited in claim 18 wherein said foot support assembly comprises two foot support members each including a foot pad connected to and outer end thereof, said foot support member movably and removably connected to a corresponding one of said side portions.

22. A chair assembly as recited in claim 21 wherein said stored orientation comprises said foot support assembly disposed exteriorly of and laterally adjacent to said side portions.

23. A chair assembly as recited in claim 22 wherein said stored orientation further comprises each of said foot support members detached from said corresponding side portions.

24. A chair assembly structured to transport a user while seated thereon, said chair assembly comprising:
a frame including a wheel assembly connected thereto, said frame selectively disposable into either an operative orientation or a collapsed orientation,
said frame comprising to side portions movably interconnected to one another and disposed in supporting relation to a seat structure,
said frame further comprising a handle assembly pivotally connected to said side portions and disposable between an extended position and a retracted position
said seat structure and a backrest both connected to an extending between said to side portions,
said side portions, said handle assembly, said seat structure and said backrest cooperatively structured to assume a compact configuration of sufficiently reduced transverse and longitudinal dimensions to facilitate storage of said frame when in said collapsed orientation.

25. A chair assembly as recited in claim 24 wherein said handle assembly comprises two handle members each pivotally connected to a different one of said side portions.

26. A chair assembly as recited in claim 25 wherein each of said handle members is movable with and relative to corresponding one of said side portions when said handle assembly is disposed between said extended and retracted positions.

27. A chair assembly as recited in claim 25 wherein each of said handle members comprises a hand grip secured thereto, each of said hand grips and at least a portion of each of said handle members are disposed in an outward, laterally adjacent relation to a corresponding one of said portions when said handle assembly is in said retracted position.

28. A chair assembly as recited in claim 27 wherein at least a portion of said backrest is pivotal with said handle members relative to said side portions as said handle assembly is disposed between said extended and retracted positions.

29. A chair assembly as recited in claim 25 wherein each of said handle members comprises a hand grip, each hand grip including an inwardly flared support flange disposed and configured to facilitate steering of said frame when in said operative orientation.

30. A chair assembly as recited in claim 29 wherein each of said hand grips and corresponding ones of said support flanges are disposed in laterally adjacent and at least partially retaining relation to corresponding side portions when said handle assembly is disposed in said retracted position.

31. A chair assembly as recited in claim 24 wherein said wheel assembly is at least partially removable from said frame.

32. A chair assembly as recited in claim 31 wherein said wheel assembly comprises front wheel structures and rear wheel structures; at least one of said front wheel structures and rear wheel structures being removably connected to said frame.
